(19) United States
(12) Patent Application Publication
(10) Pub. No.: US 2018/0374032 A1
(43) Pub. Date: Dec. 27, 2018

(54) MATCH-BASED ROUTE NAVIGATION SYSTEM

(71) Applicant: Uber Technologies, Inc., San Francisco, CA (US)

(72) Inventors: Pan Pan, San Francisco, CA (US); Jon Petersen, San Francisco, CA (US); Ronak Trivedi, San Francisco, CA (US); Matthew Zehnder, San Francisco, CA (US)

(21) Appl. No.: 15/634,172

(22) Filed: Jun. 27, 2017

(51) Int. Cl. G06Q 10/08; G01C 21/34

(52) U.S. Cl. CPC G06Q 10/083; G01C 21/3461

(57) ABSTRACT

A method and system for match-based routing are described. The network computer system receives a first transport request for a first user and performs a selection process to select a provider to fulfill the first transport request. The network computer system determines multiple navigation routes between a current location of the selected provider and a waypoint associated with the first transport request and computes a match score for each of the navigation routes. The match scores are based on probabilities of the selected provider receiving an additional transport request from an additional user while the selected provider fulfills the first transport request along that navigation route. The network computer system selects one of the navigation routes based on the computed match scores and sends data corresponding to the selected navigation route to a provider computing device of the selected provider.

### BACKGROUND

A network computer system can enable users to request and receive various services through applications executed on mobile computing devices. The network computer system typically selects a service provider to fulfill requests based on user-specific data from the request, such as the location of the user, and provider-specific data, such as the locations of nearby providers. These service providers can interact with the network computer system to accept or decline service requests, receive data about the requesting users, and set various status modes such as whether the provider is offline or online and available to fulfill requests.

### BRIEF DESCRIPTION OF THE DRAWINGS

FIG. 1 is a block diagram illustrating an example network computer system, implementing match-based route navigation, in communication with service requester devices and service provider devices, in accordance with examples described herein.

FIG. 2 illustrates an example navigation routing scenario, in accordance with aspects described herein.

FIG. 3 is a flow chart describing an example method of operating a network computer system with match-based route navigation, according to examples described herein.

FIG. 4 is a flow chart describing an example method of match-based route navigation, according to examples described herein.

FIG. 5 is a block diagram illustrating an example service provider device executing a service provider application, as described herein.

FIG. 6 is a block diagram that illustrates a computer system upon which aspects described herein may be implemented.

### DETAILED DESCRIPTION

A network computer system is provided herein that manages an on-demand network-based service linking available service providers with service requesters throughout a given region (e.g., a metroplex such as the San Francisco Bay Area). According to examples, the network computer system can receive service requests for on-demand services (e.g., transport service or delivery service) from requesting users (e.g., riders) via a designated service requester application executing on users' mobile computing devices. Based, at least in part, on the user's position, the network computer system can identify a number of proximate available service providers (e.g., drivers) and transmit a service invitation message to one or more service provider devices of the proximate available service providers to fulfill the service request (e.g., provide or perform the corresponding service).

To aid the service provider in navigating to waypoints associated with the service request, such as a pickup location or destination, the network computer system can provide street-level navigation data for route options between the current position of the service provider and any of the waypoints (or between any of the waypoints themselves). While the provider travels to each waypoint in the transport request (e.g., to the pickup location, from the pickup location to the destination, etc.), the network computer system continues to receive additional transport requests from other users. When a second user requests a ridesharing option or vehicle type (i.e., the second user is willing to share a vehicle with another user), the network computer system attempts to match the second user to an existing trip that also specified the ridesharing option, such as the one involving the first user, based on factors such as the first pickup location (or the current location of the provider if the first user has been picked up), a pickup location for the second user, the first destination, and a destination for the second user.

Rather than leaving the service provider to guess which of the route options offers greater opportunities to match with additional rideshare users, the network computer system can take into account historical match rates compiled from historical service data along the possible routes. As such, the network computer system can recommend a route where the provider has the highest probability of matching with future service requesters while fulfilling the initial service request.

According to examples described herein, the network computer system receives a first transport request for a first user and performs a selection process to select a provider to fulfill the first transport request. The network computer system determines multiple navigation routes between a current location of the selected provider and a waypoint associated with the first transport request, then computes a match score for each of the navigation routes. The match scores are based on probabilities of the selected provider receiving an additional transport request from an additional user while the selected provider fulfills the first transport request along that navigation route. The network computer system selects one of the navigation routes based on the computed match scores and sends data corresponding to the selected navigation route to a computing device of the selected provider.

In some aspects, the network computer system also takes into consideration inconvenience parameters for the users and the provider. For any given navigation route, if one or more of the inconvenience parameters exceeds a preconfigured threshold (e.g., a trip time five minutes more than other routes), the network computer system can eliminate that route since adding time to a trip can reduce provider profits, especially if driving to a user with an empty vehicle.

Among other benefits, the examples described herein achieve a technical effect of improving a computerized provider selection process between service providers and requesting users, resulting in a more efficient distribution of resources, including less idle time for providers and less waiting time for users. In addition, the examples described herein provide routing information to service providers to assist them in navigating from their current location to a waypoint in a manner that increases their likelihood of receiving additional service requests.

As provided herein, the terms “user” and “service requester” are used throughout this application interchangeably to describe a person or group of people who utilize a service requester application on a computing device to request, over one or more networks, on-demand services from a network computer system. The term “service provider” is used to describe a person utilizing a service provider application on a computing device to provide on-demand services to the service requesters.

The terms “optimal,” “optimize,” or variants thereof are intended to mean an act of achieving, through deliberate consideration, a result or outcome that is advantageous with respect to particular facets or parameters of a system. The use of such terms in reference to a given process does not necessarily mean that a result or outcome achieved is the most desirable or ideal, but rather can mean the result or outcome is more desirable with respect to particular facets or parameters as compared to an alternative process or a process that is performed without deliberate consideration for the particular facets or parameters.

One or more aspects described herein provide that methods, techniques, and actions performed by a computing device are performed programmatically or as a computer-implemented method. Programmatically means through the use of code or computer-executable instructions. A programmatically performed step may or may not be automatic.

One or more aspects described herein may be implemented using programmatic modules or components. A programmatic module or component may include a program, a subroutine, a portion of a program, a software component, or a hardware component capable of performing one or more stated tasks or functions. In addition, a module or component can exist on a hardware component independently of other modules or components. Alternatively, a module or component can be a shared element or process of other modules, programs, or machines.

Furthermore, one or more aspects described herein may be implemented through the use of instructions that are executable by one or more processors. These instructions may be carried on a computer-readable medium. Machines shown or described with figures below provide examples of processing resources and computer-readable media on which instructions for implementing some aspects can be carried out or executed. In particular, the numerous machines shown in some examples include processors and various forms of memory for holding data and instructions. Examples of computer-readable media include permanent memory storage devices, such as hard drives on personal computers or servers. Other examples of computer storage media include portable storage units, such as CD or DVD units, flash or solid state memory (such as carried on many cell phones and consumer electronic devices) and magnetic memory. Computers, terminals, network-enabled devices (e.g., mobile devices such as cell phones) are all examples of machines and devices that utilize processors, memory, and instructions stored on computer-readable media.

Alternatively, one or more examples described herein may be implemented through the use of dedicated hardware logic circuits that are comprised of interconnected logic gates. Such circuits are typically designed using a hardware description language (HDL), such as Verilog or VHDL. These languages contain instructions that ultimately define the layout of the circuit. However, once the circuit is fabricated, there are no instructions, and the processing is performed by interconnected logic gates.

System Overview

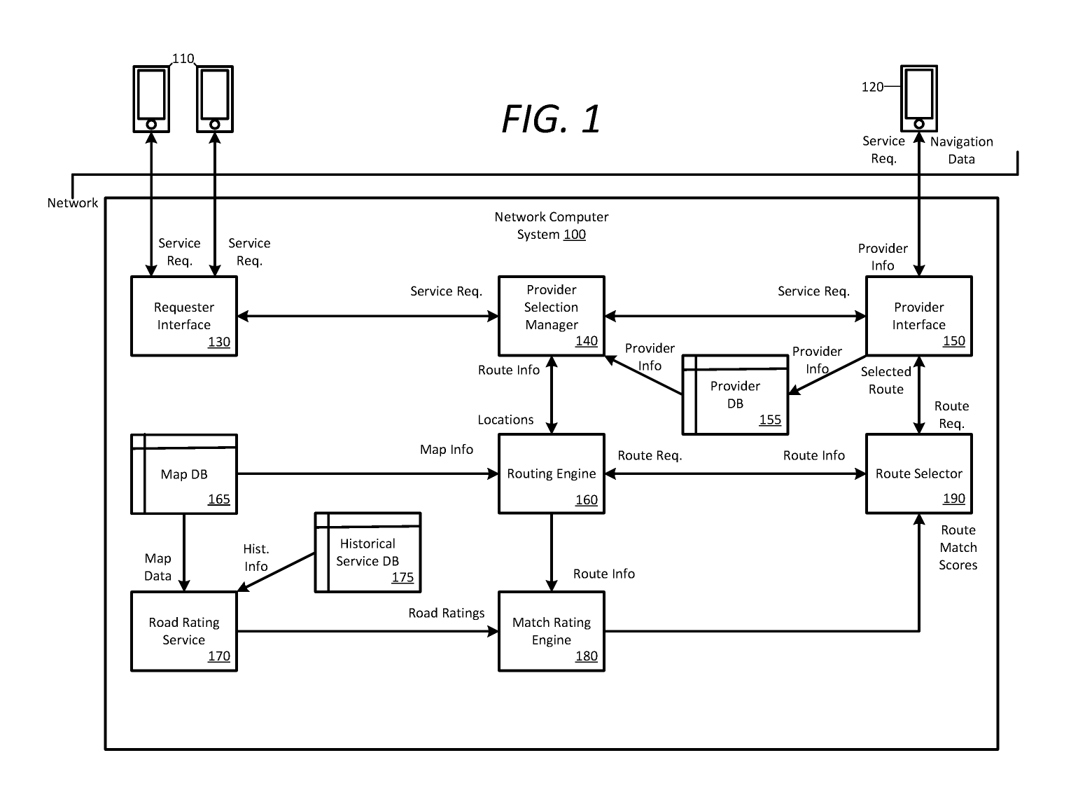

FIG. 1 is a block diagram illustrating an example network computer system, implementing match-based route navigation, in communication with service requester devices and service provider devices, in accordance with examples described herein. The network computer system 100 can implement or manage a network service (e.g., an on-demand transport or delivery arrangement service) that connects service requesters with service providers that are available to fulfill the service requests. In one example, fulfilling a service request includes driving to a pickup location to pick up a passenger and transporting the passenger to a destination. To aid the service provider in navigating to waypoints associated with the service request, such as the pickup location and destination, the network computer system 100 can provide street-level navigation data for routes between the current position of the service provider and the waypoints or between any of the waypoints themselves. In order to increase the likelihood of the service provider matching with additional users while fulfilling the first service request, the network computer system 100 can analyze potential routes and select an optimal route to display to the service provider.

The network service enables service requesters to submit requests over one or more networks through a service requester application executing on the service requester devices 110. Upon receiving service requests, a provider selection manager 140 of the network computer system 100 processes the requests to select appropriate service providers. A provider interface 150 of the network computer system 100 transmits the service requests, including information such as the pickup location, destination, and personal details of the service requester, to be displayed through a service provider application executing on the service provider devices 120.

As used herein, a service requester device 110 and a service provider device 120 can comprise computing devices with functionality to execute designated applications corresponding to the network service managed by the network computer system 100. In many examples, service requester devices 110 and service provider devices 120 can comprise mobile computing devices, such as smartphones, tablet computers, virtual reality or augmented reality headsets, on-board computing systems of vehicles, and the like. Example network services can comprise delivery of food or products, package mailing, shopping, construction, plumbing, home repair, housing or apartment sharing, and transportation arrangement services. In an example using passenger transport arrangement services, the service requesters are prospective passengers to be picked up and transported, and the service providers are drivers who transport the service requesters.

According to examples, the requester interface 130 and provider interface 150 enable the network computer system 100 to exchange data with the service requester devices 110 and the service provider devices 120 over the network. For example, the service interfaces can use one or more network resources to exchange communications over one or more wireless networks (e.g., a cellular transceiver, a WLAN transceiver, etc.). The service interfaces can include or implement externally-facing application programming interfaces (API) to communicate data with the service requester devices 110 and the service provider devices 120. The externally-facing API can provide access to the network computer system 100 via secure channels over the network through any number of methods, including web-based forms, programmatic access via restful APIs, Simple Object Access Protocol (SOAP), remote procedure call (RPC), scripting access, etc.

According to examples, service providers register with the network computer system 100, through the service provider application, to receive service invitations to fulfill service requests submitted by the service requesters. In one example using transport requests, service providers are drivers who transport the service requesters as passengers. In other examples of transport requests, service providers can transport goods such as packages or food for delivery either to or from the service requesters.

Service providers can select various states or modes within the service provider application, such as an online state that indicates the service provider is available and willing to fulfill service invitations, and a type of service offered, such as a single user transportation service or a ridesharing “pool” transportation service where a driver simultaneously transports multiple users or goods to their destinations.

In accordance with various examples, the service provider device 120 transmits provider information over the network to the provider interface 150. The provider information includes data such as the provider mode and service state, the current location of the service provider, the heading of the service provider, a number of passengers in a vehicle with the provider, etc. In some implementations, the service provider devices 120 can determine the current location of the service provider using location-based resources of the service provider devices 120 (e.g., global positioning system (GPS) resources). The service provider application can continually update the provider status on a regular schedule or in response to provider input to the service provider device 120, location changes determined by GPS, service steps performed, etc. The provider interface 150 stores the provider data in a provider database 155 (e.g., a file, in-memory data structure, relational database on a separate server, etc.) accessible by the other components of the network computer system 100 that select service areas and service providers to fulfill the service requests.

The network computer system 100 can include a service requester interface 130 to communicate with service requester devices 110 via the service requester application. In some aspects, while the service requester application is running on a service requester device 110 for a user, the application transmits requester data, including the current location of the device, to the requester interface 130. As the service requester scrolls through various service types, a user interface can update to show visual representations of the service providers for each service type on a map. The network computer system 100 can also provide estimated time to arrival (ETA) data that indicates the shortest ETA of nearby service providers for the service type. The service requester can interact with the user interface to select a particular service type, input a destination, and transmit a service request. In some examples, the service requester application can enable a user to request a ridesharing transport service (e.g., a shared transport service), which indicates that the user is open to sharing a vehicle with one or more other users.

In one example, the requester interface 130 receives a transport request from a first user which includes a pickup location of the first user, a current location of the first user if it is different than the pickup location, a destination for the first user, and identifying information such as the first user's identifier (ID) and/or the ID of the service provider device 110. In some aspects, if the first user did not specify a destination, the requester interface 130 can transmit a message or notification to the service provider device 110 requesting the first user to input or select the destination. The message can indicate that because the user specified the ridesharing option or vehicle type, the user's destination is necessary in order to match the user with other rides based on destination.

In some aspects, when the network computer system 100 receives a transport request, the provider selection manager 140 accesses the provider database 155 to retrieve a set of candidate providers based on information from the transport request and the providers' current locations and statuses. In a ridesharing example, candidate providers are drivers who are capable of providing the transport service for a requesting user (e.g., drivers that are within a predetermined distance and/or an estimated time of arrival threshold from the pickup location that satisfy the ridesharing option or vehicle type and have available space in their vehicle, etc.). For example, for a user that requests a rideshare option, candidate drivers can include drivers that are occupied (e.g., currently assigned to provide a transport service for another user that has requested the rideshare option) and/or drivers that are unoccupied but available to provide transport service (e.g., not yet assigned to provide a transport service but have agreed to be a rideshare driver).

The provider selection manager 140 can determine which one of the drivers to select based on one or more filtering operations. In one aspect, the provider selection manager 140 requests routing information, including travel time (i.e., ETA) and distance, from a routing engine 160 for each of the drivers and the pickup location specified in the service request. The provider selection manager 140 can take the ETA and distance information into account when selecting the driver to provide the transport service for the requesting user.

Once a driver is selected, the provider selection manager 140 can identify the corresponding service provider device 120 and transmit an initial invitation. The initial invitation can cause the service provider application to display information about the first user and/or the pickup location and enable the driver to accept or reject the transport service via user input.

If the driver accepts the initial invitation, the service provider device 120 can transmit an acceptance to the network computer system 100 via the provider interface 130. At this time, the network computer system 100 can update the provider database 155 and transmit a status message to the first user indicating that a driver has been selected, the driver's information, and the ETA.

In some aspects, the provider interface 150 can transmit navigation data generated for the route information from the routing engine 160 to the service provider device 120. The navigation data can correspond to a single route between the driver and the pickup location of the first user, or in other aspects, the navigation data can correspond to multiple alternative routes between the driver and the pickup location of the first user. The routing engine 160 can determine the multiple alternative routes based on various preconfigured settings and parameters such as travel time, travel distance, and reliability of each route, among other factors. The reliability of a route can represent potential variance in the travel time and includes factors such as current and historical traffic data, the number of turns in the route, the amount of backtracking in the route, heading, etc. In some examples, the routing engine 160 determines three routes to the specified waypoint that differ from each other by at least a threshold amount (i.e., the routes are not significantly identical in terms of the roads traveled). If navigation data for multiple alternative routes are sent to the service provider device 120, the driver can select between the routes on the user interface of the service provider application.

As the driver travels to each waypoint in the transport request (e.g., to the pickup location and from the pickup location to the destination), the network computer system 100 can continue to receive additional transport requests from other users. In some examples, a second user who is within a geographic region or service area proximate to the driver (e.g., as defined by a geographical boundary, or geofence as specified by three or more location data points that make up the perimeter of the geofence) can request a transport service and be willing to share a transport service. The second user's transport request can indicate the second user's selection of a ridesharing option or vehicle type (e.g., the second user is willing to share a vehicle with another user). The transport request can include a pickup location of the second user and a destination for the second user.

The provider selection manager 140 can perform one or more filtering operations to determine a plurality of candidate drivers for the second user. This plurality can include both unoccupied drivers and occupied drivers with at least one available seat in their vehicle. In one example, the provider selection manager 140 accesses the provider database 155 and/or communicates with the provider interface 150 to determine which drivers are located within a threshold distance or estimated travel time from the second pickup location. From those drivers, the provider selection manager 140 identifies a pool of candidate drivers that allow for ridesharing.

The provider selection manager 140 can then select one of the candidate drivers to provide transport service for the second user. The provider selection manager 140 can make this determination by performing score computations that are based, at least in part, on the current location of the driver, the first pickup location, the second pickup location, the first destination location, and the second destination location. In one aspect, for each candidate driver in the pool, the provider selection manager 140 determines scores associated with that candidate driver based on the first pickup location (or the current location of that candidate driver if the first user has been picked up), the second pickup location, the first destination location, and the second destination location, among other factors. Depending on implementation, the driver scores can be based on distances or can be based on a combination of distances and travel times. The provider selection manager 140 can then compare scores for the candidate drivers to determine whether the driver for the first user is a match to provide transport service for the second user. For example, the driver for the first user may have a high driver score and therefore match with the second user if the pickup location for the second user is near the driver's current location and the destination for the second user is in the same direction as the destination for the first user.

In order to increase the likelihood that a provider matches with additional users while fulfilling the first service request for the first user, a route selector 190 of the network computer system 100 can select a route, from multiple navigation routes between the current location of the provider and one or more waypoints in the first service request, based on the likelihood that the provider may match with additional users on that route. In some examples, the route selector 190 selects an optimal route from among multiple routes provided by the routing engine 160. The route selector 190 can perform the selection of the optimal route using route match scores supplied from a match rating engine 180, which rates the likelihood of the provider matching with additional users on a particular route based on historical transportation data.

In some aspects, a service application running on the service provider device 120 can send a route request to the provider interface 150 in response to a new or updated waypoint for a current service request or a new service request. For example, the service application can send the route request when the provider accepts a service request for a first user. The route request can specify the current location of the provider and the pickup location of the first user as the waypoint, and the route selector 190 can provide a navigation route to the pickup location that offers a higher likelihood of matching with a second user compared to alternative routes to the pickup location. The service application can display navigation data, including turn-by-turn directions, for the selected route on the service provider device 120. After picking up the first user, a new route request can specify the current location of the provider and the destination of the first user as the waypoint. In other examples, a pickup location or destination for a second user matched with the provider can serve as the waypoint.

In further aspects, when the provider's vehicle has no empty seats to accommodate additional passengers, the service provider device 120 can request a route based on shortest time, distance, or other factors, instead of a route that offers a higher likelihood of matching with additional passengers.

In other aspects, components of the network computer system 100, including the provider selection manager 140 and the route selector 190, can generate the route requests, and navigation data for the selected route are pushed to the service provider device 120. In one example, the route selector 190 can determine that the provider's vehicle has no empty seats to accommodate additional passengers. Based on that determination, the route selector 190 can select a route regardless of route match scores (e.g., based on shortest time, distance, or other factors).

In response to receiving the route request, the routing engine 160 can provide route information for multiple navigation routes that are chosen based on various preconfigured settings and parameters such as travel time, travel distance, and reliability of each route. The reliability of a route can represent potential variance in the travel time and includes factors such as current and historical traffic data, the number of turns in the route, the amount of backtracking in the route, heading, etc. In some examples, the routing engine 160 determines three routes to the specified waypoint that differ from each other by at least a threshold amount (i.e., the routes are not significantly identical in terms of the roads traveled). The routing engine 160 can provide routing information, including a set of turn-by-turn directions that identifies each of the road segments along a route, to a match rating engine 180.

The match rating engine 180 calculates a match score, which represents the probability of matching with a user for a provider traveling along a route, for each of the routes chosen by the routing engine 160. In some aspects, a route comprises a plurality of road segments from the start of the route to the end of the route (e.g., a current location to a waypoint, or a waypoint to another waypoint). For shorter roads, a road segment can represent the entire road. Longer roads, such as highways and freeways, can be divided into multiple road segments between points of interest (e.g., exits on a freeway) or into road segments of fixed distances. In order to calculate the match score for a route, the match rating engine 180 can retrieve a set of road ratings, provided by a road rating service 170, that indicate matching probabilities for the road segments that make up the route.

In some aspects, the road rating service 170 calculates probabilities of providers matching with users at the road segment level. The road rating service 170 can retrieve map data from a map database 165, including information for geographical areas and roads, such as distances and estimated travel time for individual road segments, speed limits, one-way roads, road closures, etc. Components of the network computer system 100 can generate and update the map data in the map database 165, or in other aspects, external services, including third-party mapping services, can provide the map data.

In addition, a historical service database 175 can provide the road rating service 170 with historical service information. In some aspects, the network computer system 100 stores data for service requesters and providers regarding service application usage and service requests, including pickup and drop off locations, times, days of the week, active users of the service application by time and area, etc. Subject to privacy policies, user opt-in and opt-out preferences, and depersonalization measures, the network computer system 100 analyzes, compiles, and stores this data into one or more databases, including the historical service database 175.

In one implementation, the historical service information and map data are divided into geographic regions, and the road rating service 170 can calculate the probability of matching with a user for a provider traveling along any particular geographic region. The regions can be based on a grid layout or take other shapes based on terrain features or road layouts. In some aspects, regions are sized such that a provider driving through the region could respond to a service request from a user anywhere else in the region within a reasonable amount of time (e.g., five minutes). Therefore, the size of regions can depend on speed limits, traffic, and road layouts. Each geographic region has associated statistics that the road rating service 170 uses to determine matching probabilities for that region. These statistics can include pickup and drop off locations, active users of the service application by time and area, and the frequency and types of service requests at various times of the day, days of the week, months, or in certain conditions such as weather and traffic, etc. In this implementation, in order to calculate road ratings for a given road segment, the road rating service 170 can determine which geographic region or regions a given road segment is located in and assign the road segment a road rating based on the corresponding region or regions. For example, if a road segment is located within a geographic region that sees one service request per minute on average, the road rating for that road segment can reflect that one service request per minute statistic. In another example, if the historical service information breaks that geographic region average into time slots, the road rating service 170 may assign the road segment a road rating reflecting a one service request per minute average at 3:00 PM, a two service request per minute average at 4:00 PM, etc.

In addition to calculating match rates for road segments based on service requests for a geographic region as a whole, the road rating service 170 can calculate the match rates based on a direction of travel. For example, a given geographic region may see an average of one service request per minute that specify a destination east of the geographic region and an average of two service requests per minute with a destination west of the geographic region. Therefore, in some aspects, the historical service database 175 stores statistics for service requests that originate in a geographic region based on destinations in a plurality of directions (e.g., the four cardinal directions, towards/away from a major city, north/south along a freeway, etc.).

In situations where a road segment crosses multiple geographic regions, the road rating service 170 can assign road ratings based on a combination of the statistics for each region or based on which region the road segment is mostly located within. Alternatively, map data, historical service information, and route info can divide roads into segments that end at the borders of geographic regions.

In some aspects, an offline service updates the historical service database 175 with service statistics for the geographic regions that the road rating service 170 uses to determine matching probabilities for road segments in each region. The offline service can recalculate the service statistics for the geographic regions on a schedule, such as nightly or once per week. In other aspects, the road rating service 170 scores road segments independent of geographic region, and the historical service information can include service statistics tied to the road segments themselves.

In some aspects, the match rating engine 180 queries the road rating service 170 for appropriate road ratings for the road segments that comprise each of the routes received from the routing engine 160. For example, the match rating engine 180 can query the road rating service 170 to request a road rating, or match rate, for trips from point A to point B on a route given specific parameters, such as the time of day, day of the week, month, weather conditions, etc., based on the historical service information for the geographic region encompassing the road segment. The road rating service 170 can then calculate the road rating using the geographic region statistics from the historical service information, taking into account the specified parameters, including the direction of travel from point A to point B.

With road ratings for each of the road segments that comprise a route, the match rating engine 180 aggregates the individual ratings in order to calculate a route match score for the route as a whole. In one implementation, the route match score represents the probability of matching with a user for a provider traveling along that route from the provider's current location to a waypoint. In aggregating the road ratings, the match rating engine 180 can apply weights to the road ratings for each of the road segments. For example, the match rating engine 180 can weight each road segment based on its proportion of the total distance or expected travel time of the entire route. In other examples, the match rating engine 180 can apply higher weights to road segments earlier in the route and lower weights to road segments later in the route, thereby prioritizing routes in which a provider is more likely to receive a second service request sooner.

In one implementation, the road rating service 170 and/or match rating engine 180 can include real-time data in the road ratings and route match scores. For example, the road rating service 170 can receive data indicating a likelihood of higher than usual demand, such as a large event (e.g., concert, football game, etc.) that may result in users submitting service requests to travel to or from the event. Other real-time data that may affect demand can include a number of users with a service requester application open and real-time traffic updates. Accordingly, the road rating service 170 can increase or decrease the probability of matching with a user for a provider traveling along a given road segment that may be affected by the real-time data.

The match rating engine 180 provides the route match scores, for each of the navigation routes to the waypoint that the routing engine 160 generated, to the route selector 190. In one implementation, the route selector 190 selects the route that gives the provider the highest probability of matching with a user for a second service request. In an alternate implementation, the route match score can represent an expected time for the provider to receive a second service request, based on weighting applied by the match rating engine 180 to the road segments comprising the route, and the route selector 190 can select the navigation route with the earliest expected time.

In further implementations, the routing engine 160 can implement the functions of the match rating engine 180 in order to optimize the selection of navigation route based on both the match scores and route efficiency (e.g., time, distance, and reliability) simultaneously. In these implementations, the routing engine 160 can access the map database 165 and historical service database 175 to calculate route match scores for the route selector 190.

In some aspects, the route selector 190 also takes into consideration inconvenience parameters for the users and the provider. For any given navigation route, if one or more of the inconvenience parameters exceeds a preconfigured threshold, the route selector 190 can eliminate that route. For example, if one navigation route would take more than five minutes longer than the fastest route to the waypoint, the route selector 190 may select a different route, even if the different route has a worse match score (lower probability of a match, longer expected time for a match, etc.). The inconvenience parameters and thresholds may be adjusted or customized based on the user or location of the service.

Once the route is selected, the provider interface 150 can send navigation data, including turn-by-turn directions, for the selected route to be displayed on the service provider device 120.

### EXAMPLE

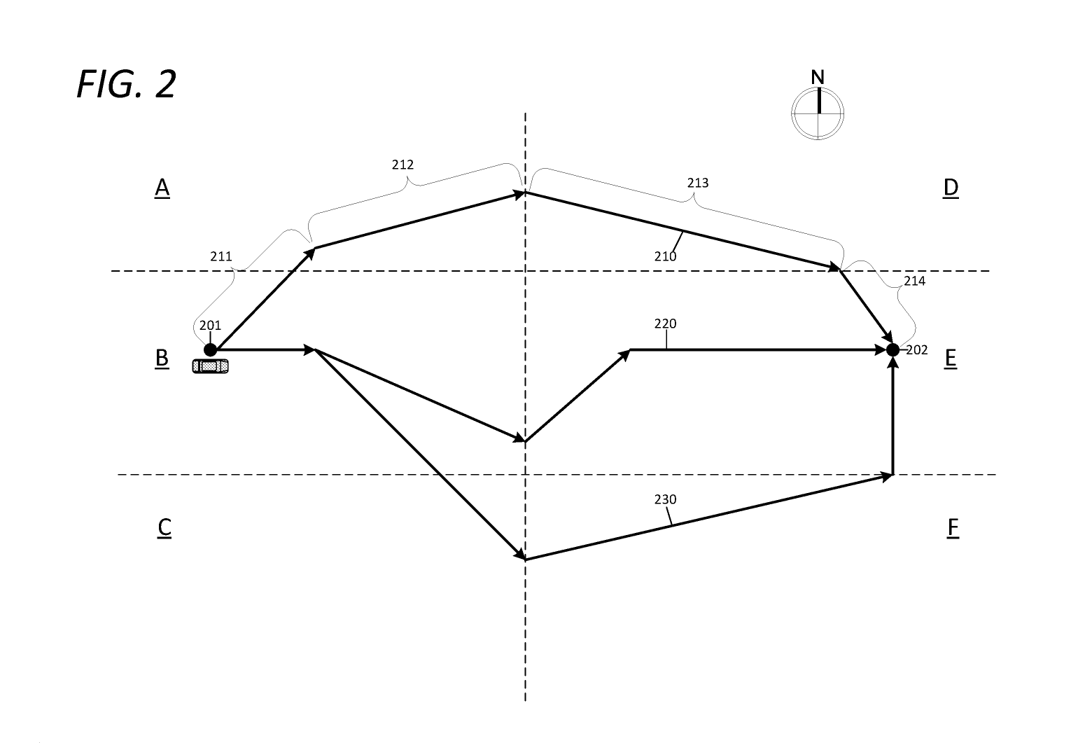

FIG. 2 illustrates an example navigation routing scenario, in accordance with aspects described herein. In the example illustrated, a routing engine 160 of the network computer system 100 has determined three possible routes 210, 220, 230 between the current location 201 of a provider and a waypoint 202 for a first transport request. The waypoint 202 can represent a pickup location set by the user who submitted the first transport request, or if the provider has already picked up the user (or picked up an object subject to the first transport request), the waypoint 202 can represent a destination drop-off location.

In order to optimize the provider selection process and the likelihood of the provider receiving additional requests while providing service to a current user, the network computer system 100 can use historical service information to compare the three possible routes 210, 220, 230 to select the route that provides the highest probability of the provider matching with an additional user while traveling from the current location 201 to the waypoint 202. In some aspects, the network computer system 100 calculates a match score for each of the routes 210, 220, 230 and compares the match scores to select one of the routes.

In one implementation, the historical service information and map data are divided into geographic regions (illustrated as regions A, B, C, D, E, and F). The regions can be based on a grid layout or take other shapes based on terrain features or road layouts. In some aspects, regions are sized such that a provider driving through the region could respond to a service request from a user anywhere else in the region within a reasonable amount of time (e.g., five minutes). Therefore, the size of regions can depend on speed limits, traffic, and road layouts. Each geographic region has associated statistics that are used to determine matching probabilities for that region. These statistics can include pickup and drop off locations, active users of the service application by time and area, and the frequency and types of service requests at various times of the day, days of the week, months, or in certain conditions such as weather and traffic, etc.

In some aspects, the network computer system 100 divides a route into a plurality of road segments from the start of the route to the end of the route (i.e., current location 201 to waypoint 202). As illustrated, route 210 is divided into four road segments 211, 212, 213, 214. In order to determine the probability of matching with an additional user for a provider traveling along each road segment, the network computer system 100 can determine which geographic region or regions the road segment is located in and assign the road segment a road rating based on the statistics for the corresponding region or regions. For example, if geographic region D sees one service request per minute on average, then the rating for road segment 213, which is located in region D, can reflect that one service request per minute statistic. In a further example, if the historical service information breaks that geographic region average into time slots, the network computer system 100 may assign a specific road segment a road rating reflecting a one service request per minute average at 3:00 PM, a two service request per minute average at 4:00 PM, etc.

In addition to calculating match rates for road segments based on service requests for a geographic region as a whole, the network computer system 100 can calculate the match rates based on a direction of travel. For example, geographic region D may see an average of one service request per minute with a destination east of the geographic region and an average of two service requests per minute with a destination west of the geographic region. Therefore, since road segment 213 on route 210 points substantially east, the road rating for road segment 213 can reflect the one service request per minute statistic.

In situations where a road segment crosses multiple geographic regions, such as road segment 211, the network computer system 100 can assign road ratings based on a combination of the statistics for each region or based on which region the road segment is mostly located within.

With road ratings for each of the road segments that comprise a route, the network computer system 100 aggregates the individual ratings in order to calculate a route match score for the route as a whole. In one implementation, the route match score represents the probability of matching with a user for a provider traveling along that route from the provider's current location 201 to the waypoint 202. In aggregating the road ratings, the network computer system 100 can apply weights to the road ratings for each of the road segments. For example, if the provider is expected to spend twice as long traveling the distance of road segment 213 compared to road segment 212, the network computer system 100 can weight road segment 213 twice as heavily as road segment 212.

In some aspects, the network computer system 100 also takes into consideration inconvenience parameters for the users and the provider. For any given navigation route, if one or more of the inconvenience parameters exceeds a preconfigured threshold, the network computer system 100 can eliminate that route. For example, if route 230 would take more than five minutes longer than either route 210 or 220, the network computer system 100 may select route 210 or 220, even if they have worse match scores than route 230 (lower probability of a match, longer expected time for a match, etc.).

Once the route is selected, the network computer system 100 can send navigation data, including turn-by-turn directions, for the selected route to be displayed on the service provider device 120.

Methodology

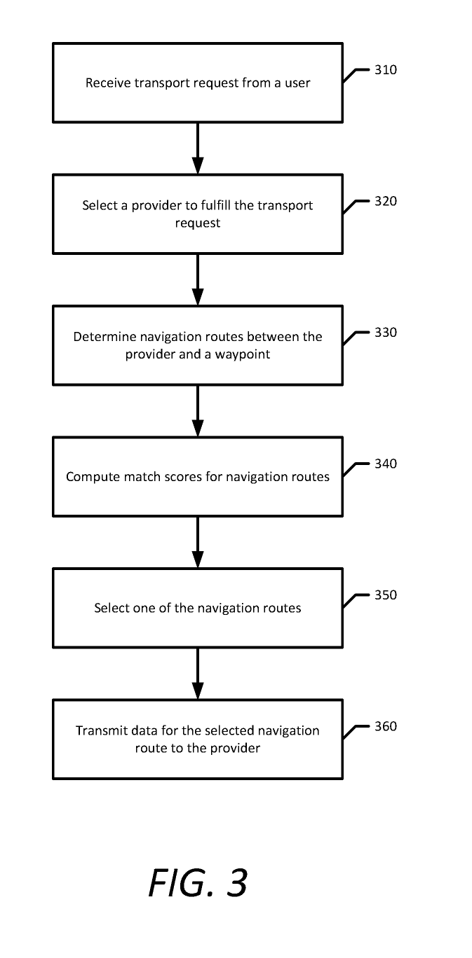

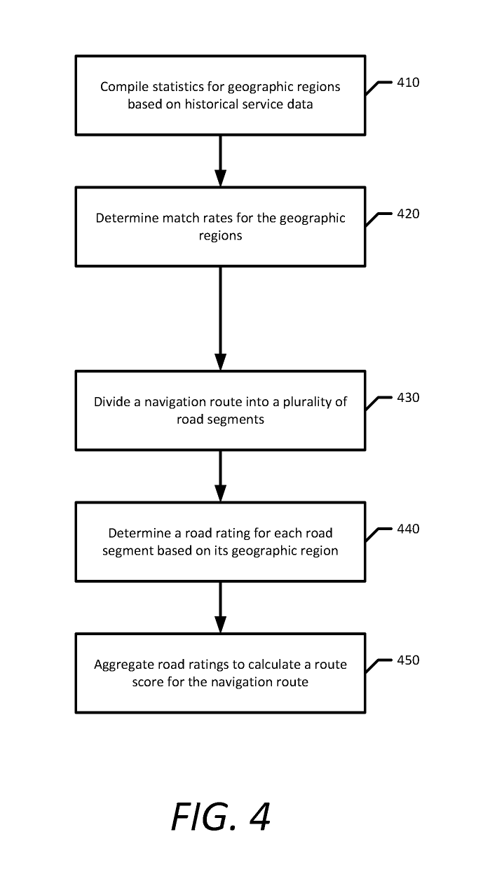

FIGS. 3 and 4 are flow charts describing example methods used in match-based route navigation. Although some operations of the methods are described below as being performed by specific components of the network computer system 100 illustrated in FIG. 1, it will be appreciated that these operations need not necessarily be performed by the specific components identified, and could be performed by a variety of components and modules, potentially distributed over a number of physical or virtual machines located on-site with the network computer system 100 or in communication over one or more networks. Accordingly, references may be made to elements of the network computer system 100 for the purpose of illustrating suitable components or elements for performing a step or sub-step being described. Alternatively, at least some of the variety of components and modules described as part of the network computer system 100 can be arranged within a single hardware, software, or firmware component. It will also be appreciated that some of the steps of these methods may be performed in parallel or in a different order than illustrated.

FIG. 3 is a flow chart describing an example method of operating a network computer system 100 with match-based route navigation. In one example, the network computer system 100 receives a transport request from a first user which includes a pickup location of the first user, a current location of the first user, a destination for the first user, and identifying information for the first user or user device (310).

The network computer system 100 retrieves a set of candidate providers based on information from the transport request and the providers' current locations and statuses. In a ridesharing example, candidate providers are drivers who are capable of providing the transport service for the first user (e.g., drivers that are within a predetermined distance and/or an estimated time of arrival threshold from the pickup location, that satisfy the ridesharing option or vehicle type, that have available space in their vehicle, etc.). For example, for a user that requests a rideshare option, candidate drivers can include drivers that are occupied (e.g., currently assigned to provide a transport service for another user that has requested the rideshare option) and/or drivers that are unoccupied but available to provide transport service (e.g., not yet assigned to provide a transport service but have agreed to be a rideshare driver or vehicle type).

The network computer system 100 can determine which one of the providers to select based on one or more filtering operations. In one aspect, the network computer system 100 determines routing information, including an estimated time of arrival (ETA), for each of the providers to the pickup location specified in the service request. The network computer system 100 can use the ETA, among other factors, to select a provider to fulfill the transport request for the first user (320).

As the provider fulfills the transport request, the network computer system 100 can receive a second request for transport service from a second user who has requested or indicated that he or she is willing to share a ride with another user. The network computer system 100 can then determine whether the first driver transporting the first user and the second user satisfy conditions (in relation to the first driver) so that the first driver should provide transport service for the second user as part of the transport service already arranged for the first user. The network computer system 100 can make this determination based, at least in part, on a first pickup location of the first user (or alternatively, a current location of the first driver), a second pickup location of the second user, a first destination location of the first user, and a second destination location of the second user.

In order to optimize the provider selection process and the likelihood of the provider receiving additional requests while providing service to a current user, the network computer system 100 can compare a number of navigation route possibilities that the provider could use to reach one or more of the service waypoints. The network computer system 100 can determine route information for multiple navigation routes that are chosen based on various preconfigured settings and parameters such as travel time, travel distance, and reliability of each route. The reliability of a route can represent potential variance in the travel time and includes factors such as current and historical traffic data, the number of turns in the route, the amount of backtracking in the route, etc. In some examples, the network computer system 100 determines three routes to the specified waypoint that differ from each other by at least a threshold amount (i.e., the routes are not significantly identical in terms of the roads traveled) (330).

The network computer system 100 can calculate a route match score, which represents the probability of matching with a user for a provider traveling along a route, for each of the routes (340). In some examples, the network computer system 100 calculates the route match scores using historical service data compiled from previous service requests and service application usage, among other sources.

In one implementation, the network computer system 100 selects the route that gives the provider the highest probability of matching with a user for a second service request (350). In an alternate implementation, the route match score can represent an expected time for the provider to receive a second service request, based on weighting applied to the road segments comprising the route, and the network computer system 100 can select the navigation route with the earliest expected time.

Once the route is selected, the network computer system 100 can send navigation data, including turn-by-turn directions, for the selected route to be displayed to the provider on a service provider device (360).

FIG. 4 is a flow chart describing an example method of match-based route navigation, according to examples described herein. In some aspects, the network computer system 100 stores data for service requesters and providers regarding service application usage and service requests, including pickup and drop off locations, times, days of the week, active users of the service application by time and area, etc. Subject to privacy policies, user opt-in and opt-out preferences, and depersonalization measures, the network computer system 100 analyzes, compiles, and stores this data into one or more databases (410).

In one implementation, the historical service information and map data are divided into geographic regions. The regions can be based on a grid layout or take other shapes based on terrain features or road layouts. In some aspects, regions are sized such that a provider driving through the region could respond to a service request from a user anywhere else in the region within a reasonable amount of time (e.g., five minutes). Therefore, the size of regions can depend on speed limits, traffic, and road layouts.

In some aspects, an offline service updates a historical service database with service statistics for the geographic regions that the network computer system 100 uses to determine matching probabilities for that region (420). These statistics can include pickup and drop off locations, active users of the service application by time and area, and the frequency and types of service requests at various times of the day, days of the week, months, or in certain conditions such as weather and traffic, etc. The offline service can recalculate the service statistics for the geographic regions on a schedule, such as nightly or once per week.

In some aspects, the network computer system 100 divides a navigation route into a plurality of road segments from the start of the route to the end of the route (e.g., a current location of a provider to a waypoint, or a waypoint to another waypoint) (430). For shorter roads, a road segment can represent the entire road. Longer roads, such as highways and freeways, can be divided into multiple road segments between points of interest (e.g., exits on a freeway) or into road segments of fixed distances.

In one implementation, in order to calculate road ratings for a given road segment, the network computer system 100 determines which geographic region or regions the road segment is located in and assigns the road segment a road rating based on the corresponding region or regions (440). For example, if a specific road segment is located within a geographic region that sees one service request per minute on average, the road rating for that road segment can reflect that one service request per minute statistic. In another example, if the historical service information breaks that geographic region average into time slots, the network computer system 100 may assign a specific road segment a road rating reflecting a one service request per minute average at 3:00 PM, a two service request per minute average at 4:00 PM, etc.

In addition to calculating match rates for road segments based on service requests for a geographic region as a whole, the network computer system 100 can calculate the match rates based on a direction of travel. For example, a given geographic region may see an average of one service request per minute with a destination east of the geographic region and an average of two service requests per minute with a destination west of the geographic region. Therefore, in some aspects, the historical service database separately stores statistics for service requests that originate in a geographic region based on destinations in a plurality of directions (e.g., the four cardinal directions, towards/away from a major city, or north/south along a freeway).

In situations where a road segment crosses multiple geographic regions, the network computer system 100 can assign road ratings based on a combination of the statistics for each region or based on which region the road segment is mostly located within. Alternatively, map data, historical service information, and route info can divide roads into segments that end at the borders of geographic regions.

With road ratings for each of the road segments that comprise a route, the network computer system 100 aggregates the individual ratings in order to calculate a route match score for the route as a whole (450). In one implementation, the route match score represents the probability of matching with a user for a provider traveling along that route from the provider's current location to a waypoint. In aggregating the road ratings, the network computer system 100 can apply weights to the road ratings for each of the road segments. For example, the network computer system 100 can weight each road segment based on its proportion of the total distance or expected travel time of the entire route. In other examples, the network computer system 100 can apply higher weights to road segments earlier in the route and lower weights to road segments later in the route, thereby prioritizing routes in which a provider is more likely to receive a second service request sooner.

Service Provider Device

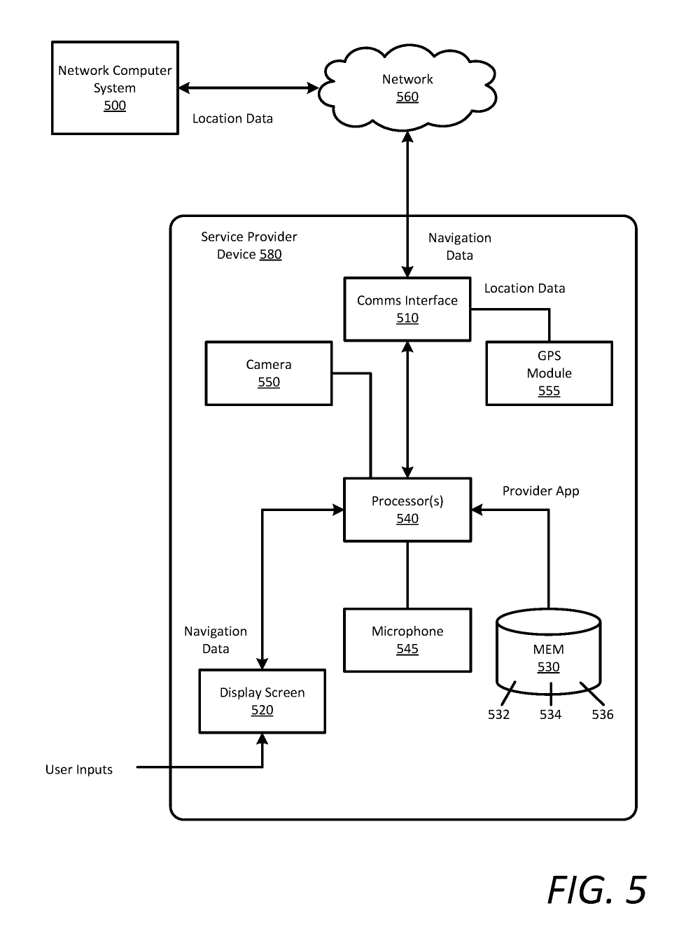

FIG. 5 is a block diagram illustrating an example service provider device executing a designated service provider application for an on-demand service, as described herein. In many implementations, the service provider device 580 can comprise a mobile computing device, such as a smartphone, tablet computer, laptop computer, VR or AR headset device, and the like. As such, the service provider device 580 can include typical telephony features such as a microphone 545, a camera 550, and a communication interface 510 to communicate with external entities using any number of wireless communication protocols. In certain aspects, the service provider device 580 can store a designated application (e.g., a service provider application 532) in a local memory 530. In many aspects, the service provider device 580 further stores information corresponding to a contacts list 534 and calendar appointments 536 in the local memory 530. In variations, the memory 530 can store additional applications executable by one or more processors 540 of the service provider device 580, enabling access and interaction with one or more host servers over one or more networks 560.

In response to user input, a processor 540 can execute the service provider application 532, which can cause an application interface to be generated on a display screen 520 of the service provider device 580. The application interface can enable the service provider to, for example, accept incoming service requests, request routes to a waypoint, and change modes (e.g., online, offline, ridesharing mode, etc.).

As provided herein, the service requester application 532 can further enable a communication link with a network computer system 500 over the network 560, such as the network computer system 100 as shown and described with respect to FIG. 1. Furthermore, as discussed herein, the service requester application 532 can display navigation data, including turn-by-turn directions to a waypoint for a service request, on the application interface. In addition, the application interface can display information regarding a current service requester and any service request, including a service location, estimated time to arrival or destination, a picture of the service requester, etc.

In various examples, the service provider device 580 can further include a GPS module 555, which can provide location data indicating the current location of the provider to the network computer system 500 so that the system can match the service provider with appropriate service requesters and provide navigation data from the provider's current location to a waypoint.

In alternative aspects, hard-wired circuitry may be used in place of, or in combination with, software instructions to implement aspects described herein. Thus, aspects described are not limited to any specific combination of hardware circuitry and software configuration.

Hardware Diagram

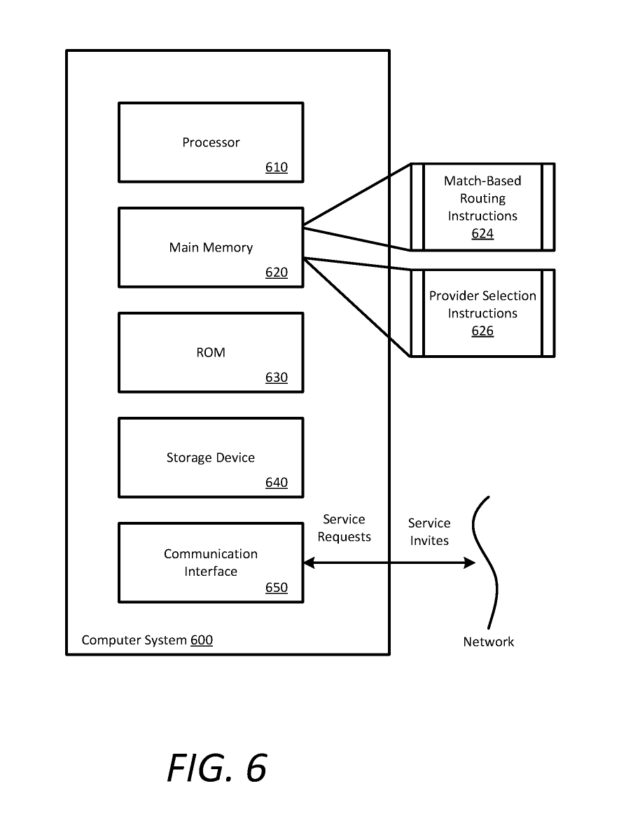

FIG. 6 is a block diagram that illustrates a computer system upon which examples described herein may be implemented. A computer system 600 can represent, for example, hardware for a server or combination of servers that may be implemented as part of a network service for providing on-demand services. In the context of FIG. 1, the network computer system 100 may be implemented using a computer system 600 or combination of multiple computer systems 600 as described by FIG. 6.

In one aspect, the computer system 600 includes processing resources (processor 610), a main memory 620, a read-only memory (ROM) 630, a storage device 640, and a communication interface 650. The computer system 600 includes at least one processor 610 for processing information stored in the main memory 620, such as provided by a random access memory (RAM) or other dynamic storage device, for storing information and instructions which are executable by the processor 610. The main memory 620 also may be used for storing temporary variables or other intermediate information during execution of instructions to be executed by the processor 610. The computer system 600 may also include the ROM 630 or other static storage device for storing static information and instructions for the processor 610. A storage device 640, such as a magnetic disk or optical disk, is provided for storing information and instructions.

The communication interface 650 enables the computer system 600 to communicate with one or more networks (e.g., a cellular network) through use of a network link (wireless or wired). Using the network link, the computer system 600 can communicate with one or more computing devices, one or more servers, and/or one or more self-driving vehicles. In accordance with some examples, the computer system 600 receives service requests from mobile computing devices of individual users. The executable instructions stored in the memory 630 can include match-based routing instructions 624 and provider selection instructions 626 to perform one or more of the methods described herein when executed.

By way of example, the instructions and data stored in the memory 620 can be executed by the processor 610 to implement an example network computer system 100 of FIG. 1. In performing the operations, the processor 610 can handle service requests and provider statuses and submit service invitations to facilitate fulfilling the service requests. The processor 610 executes instructions for the software and/or other logic to perform one or more processes, steps and other functions described with implementations, such as described by FIGS. 1 through 5.

Examples described herein are related to the use of the computer system 600 for implementing the techniques described herein. According to one example, those techniques are performed by the computer system 600 in response to the processor 610 executing one or more sequences of one or more instructions contained in the main memory 620. Such instructions may be read into the main memory 620 from another machine-readable medium, such as the storage device 640. Execution of the sequences of instructions contained in the main memory 620 causes the processor 610 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mention of the particular feature. Thus, the absence of describing combinations should not preclude claiming rights to such combinations.

What is claimed is:

1. A network computer system for match-based routing comprising:
one or more processors; and
one or more memory resources storing instructions that, when executed by the one or more processors, cause the network computer system to:
receive, from a first computing device over a network, a first transport request for a first user;
perform a selection process to select a provider, from a plurality of candidate providers, to fulfill the first transport request;
generate a plurality of navigation routes between a current location of the selected provider and a waypoint associated with the first transport request;
compute a match score for each of the plurality of navigation routes, wherein each match score is based on a probability of the selected provider receiving an additional transport request from an additional user while the selected provider fulfills the first transport request along each of the navigation routes;
select one of the plurality of navigation routes based on the computed match scores; and
send data corresponding to the selected navigation route to a provider computing device of the selected provider.

2. The network computer system of claim 1, further comprising instructions to:
divide each of the plurality of navigation routes into a plurality of road segments;
generate, for each of the road segments, road ratings that represent the probability of the selected provider receiving the additional transport request while the selected provider fulfills the first transport request along that road segment; and
compute the match score for each of the plurality of navigation routes based on the road ratings for the road segments that comprise that navigation route.

3. The network computer system of claim 2, wherein the road ratings are determined based on historical transport request data and user data collected by the network computer system.

4. The network computer system of claim 3, wherein the historical transport request data and the user data are associated with specific geographic regions, and determining the road ratings for a given road segment includes determining which specific geographic region the given road segment is located within.

5. The network computer system of claim 1, wherein the waypoint is a pickup location for the first user or a destination selected by the first user.

6. The network computer system of claim 5, wherein fulfilling the first transport request includes at least one or more of driving to the pickup location and driving to the destination.

7. The network computer system of claim 1, wherein selecting one of the plurality of navigation routes is further based on one or more inconvenience factors and inconvenience thresholds.

8. The network computer system of claim 1, wherein the first transport request is to transport food, merchandise, or other items.

9. A method of match-based navigation routing, the method being implemented by one or more processors and comprising:
receiving, from a first computing device over a network, a first transport request for a first user;
performing a selection process to select a provider, from a plurality of candidate providers, to fulfill the first transport request;
generating a plurality of navigation routes between a current location of the selected provider and a waypoint associated with the first transport request;
computing a match score for each of the plurality of navigation routes, wherein each match score is based on a probability of the selected provider receiving an additional transport request from an additional user while the selected provider fulfills the first transport request along each of the navigation routes;
selecting one of the plurality of navigation routes based on the computed match scores; and
sending data corresponding to the selected navigation route to a provider computing device of the selected provider.

10. The method of claim 9, further comprising:
dividing each of the plurality of navigation routes into a plurality of road segments;
generating, for each of the road segments, road ratings that represent the probability of the selected provider receiving the additional transport request while the selected provider fulfills the first transport request along that road segment; and
computing the match score for each of the plurality of navigation routes based on the road ratings for the road segments that comprise that navigation route.

11. The method of claim 10, wherein the road ratings are determined based on historical transport request data and user data.

12. The method of claim 11, wherein the historical transport request data and the user data are associated with specific geographic regions, and determining the road ratings for a given road segment includes determining which specific geographic region the given road segment is located within.

13. The method of claim 9, wherein the waypoint is a pickup location for the first user or a destination selected by the first user.

14. The method of claim 13, wherein fulfilling the first transport request includes at least one or more of driving to the pickup location and driving to the destination.

15. The method of claim 9, wherein selecting one of the plurality of navigation routes is further based on one or more inconvenience factors and inconvenience thresholds.

16. The method of claim 9, wherein the first transport request is to transport food, merchandise, or other items.

17. A non-transitory computer-readable medium that stores instructions, executable by one or more processors, to cause the one or more processors to perform operations that comprise:
receiving, from a first computing device over a network, a first transport request for a first user;
performing a selection process to select a provider, from a plurality of candidate providers, to fulfill the first transport request;
generating a plurality of navigation routes between a current location of the selected provider and a waypoint associated with the first transport request;
computing a match score for each of the plurality of navigation routes, wherein each match score is based on a probability of the selected provider receiving an additional transport request from an additional user while the selected provider fulfills the first transport request along each of the navigation routes;
selecting one of the plurality of navigation routes based on the computed match scores; and
sending data corresponding to the selected navigation route to a provider computing device of the selected provider.

18. The non-transitory computer-readable medium of claim 17, further comprising:
dividing each of the plurality of navigation routes into a plurality of road segments;
generating, for each of the road segments, road ratings that represent the probability of the selected provider receiving the additional transport request while the selected provider fulfills the first transport request along that road segment; and
computing the match score for each of the plurality of navigation routes based on the road ratings for the road segments that comprise that navigation route.

19. The non-transitory computer-readable medium of claim 18, wherein the road ratings are determined based on historical transport request data and user data.

20. The non-transitory computer-readable medium of claim 19, wherein the historical transport request data and the user data are associated with specific geographic regions, and determining the road ratings for a given road segment includes determining which specific geographic region the given road segment is located within.
